(19) United States
(12) Patent Application Publication
(10) Pub. No.: US 2008/0191880 A1
(43) Pub. Date: Aug. 14, 2008

(54) Security Label

(75) Inventors: David Tuffe, Hamburg (DE); Aranzazu Escudero Vallejo, Hamburg (DE); Thilo Dollase, Hamburg (DE)

Correspondence Address: NORRIS, MCLAUGHLIN & MARCUS, 875 THIRD AVE, 18TH FLOOR, NEW YORK, NY, 10022, US

(73) Assignee: TESA AG, Hamburg (DE)

(21) Appl. No.: 12/024,738

(22) Filed: Feb. 1, 2008

(30) Foreign Application Priority Data
Feb. 12, 2007 (DE) 102007007413.3

(51) Int. Cl. G08B 13/14

(52) U.S. Cl. 340/572.1

(57) ABSTRACT

Security label for use as a detector of first-time opening of an article, having an adhesive layer for application to the article, and a detection layer, the detection layer having an optical feature which irreversibly indicates an attempt at detachment from the article, the security label having an extensibility of at least 50% and being removable substantially without residue from the article by stretching, characterized in that the security label has a predetermined breakage point at which the security label can be divided into two parts on first-time opening.

### BACKGROUND OF THE INVENTION

1. Field of the Invention

The present invention relates to a security label for use as a detector of first-time opening.

2. Background

Security labels are typically used to indicate the first-time opening of an article, such as a door or a box, which is labelled with the security label. For this purpose, security labels of this kind have an optical feature which irreversibly indicates an attempt at opening, such as detachment from the article bearing the security label. To this extent the security labels serve as seals for the integrity of the article prior to first-time opening. To this end the security label is adhered to the article in such a way that the article cannot be opened without detachment or destructive cutting of the security label. For this purpose this security label must be joined to the article in such a way that detachment and subsequent reapplication are impossible without visible detractions. This is typically achieved by means of an appropriate adhesive bond to the article, in combination with an optical feature. For the present purposes the term “security label” embraces not only embodiments having confined dimensions, such as diecuts, but also tapelike embodiments, such as adhesive tapes.

Security labels of this kind are known from the prior art (WO 97/44769 A1; EP 0 205 457 B1). Security labels are available commercially, such as, for example, under the product name tesa® SecuritySeal. One possible construction for security labels is a layer structure having layers which adhere to one another to differing extents. Before a first attempt at detachment, this layer structure is typically unrecognizable to the naked eye. In the event of an attempt at detachment, however, the layer structure is destroyed as a result of the different bond strengths, so leaving a visible detraction from the security label, which cannot be reversed even by bonding the affected layers back together. This detraction may consist, for example, in an indicium becoming recognizable as a result of the detachment of individual layers.

A problem associated with security labels of this kind is the residue-free detachment of a security label from the article after said label has been used. Such removal is often possible only with a high degree of mechanical effort or with the use of solvents. Both are often undesirable, owing to the high personnel costs and owing to the detraction from the surface of the article that accompanies any cleaning procedure.

There is therefore a need for security labels which on the one hand function as detectors of first-time opening but on the other hand are redetachable without residue. Residuelessly redetachable self-adhesive strips are known per se. The prior art, for example, discloses adhesive strips which can be redetached substantially without residue by stretching, also referred to as “stripping” (U.S. Pat. No. 4,024,312; EP 0 563 272 B1). One example of products available commercially is tesa® Power Strips®. These different adhesive strips have the common feature that the pressure-sensitive adhesives used therein have an unusually high cohesiveness and extensibility, thereby enabling the stretching to take place.

The prior art (U.S. Pat. No. 6,372,341 B1), moreover, discloses a security label which not only irreversibly indicates an attempt at opening but can also be detached without residue from the bond substrate by stripping. This security label therefore solves the problem of residue-free removal from the bond substrate. In order to allow the security label to be stripped and thus detached without residue from the article, it is required to have a high tensile strength. This high tensile strength, however, means that the adhesive tape must first be destructively cut or detached from the article prior to the opening of the sealed article. A further problem is that, as a result of the separation of the different layers of the security label on detachment, shreds of the individual layers of the product may form, and may slip off uncontrolledly and enter air ducts or joints, for example. Controlling such shreds of product is difficult, especially under adverse conditions such as darkness or draught. The problem addressed by the present invention is therefore that of specifying a security label which not only can function as a detector of first-time opening and can be redetached without residue, but which also, moreover, is optimized for ease of handling.

### SUMMARY OF THE INVENTION

The foregoing disadvantages of the prior art are overcome by providing a security label for use as a detector of first-time opening of an article, having an adhesive layer for application to the article, and a detection layer. The detection layer has an optical feature which irreversibly indicates an attempt at detachment from the article. The security label has an extensibility of at least 50% and being removable substantially without residue from the article by stretching. The security label has a predetermined breakage point at which the security label can be divided into two parts on first-time opening. Also, the security label, by virtue of the opening of the article, is stretchable and is detachable substantially without residue from the article at least one one side. Methods of the invention for the substantially residue-free detachment of a security label are also provided by disclosing a method of detaching a security label without residue from an article secured with a security label, wherein the article is opened, and wherein, as a result of the opening operation, the security label is divided into two parts, and wherein each individual part is detached substantially without residue by stretching, preferably starting from the predetermined breakage point. In addition, a method is provided wherein the article is opened, and wherein the security label, as a result of the opening operation, is stretched and is detached substantially without residue from the article at least on one side.

Preferred developments are subject matter of the respective dependent claims.

In accordance with the invention it has been recognized that it is not always necessary or possible to remove the security label prior to the opening of the article secured with the label. On account of the high tensile strength, however, to do so is absolutely necessary in the case of the security label known from the prior art. In one preferred version, therefore, the security label of the invention has a predetermined breakage point, at which, on first-time opening, the security label can be separated into—for example—two parts. It is therefore possible to open the article without great application of force even with the security label still bonded. During the process of opening itself, the security label is broken at the predetermined breakage point into two parts, which in this case remain joined to the article, so not producing any shreds of product which can slip away uncontrolledly. The residue-free removal of the security label from the article, however, remains possible, since the two parts are each detachable from the article independently of one another, by stripping.

In the case of an alternative solution of equal standing according to claim 4, the security label is detached from the article by stripping, at least partially, preferably completely, at least on one side, in any case, by the opening process itself. The process of opening the article, a door for example, thus initiates the stripping process, and the stripping process is concluded if the article is opened further accordingly. The security label is then particularly easy to detach from the second side, since the first side of the security label is able to serve as a grip tab for further stripping.

The security label of the invention has an adhesive layer by means of which it can be affixed to the article to be labelled. There is also a detection layer, which irreversibly indicates an attempt at detachment. The detection layer may comprise a single layer, or may alternatively, in a way which is known from the prior art, be composed of two or more layers. The key feature is that the detection layer has an optical feature through which detachment, even partial detachment, of the security label from the article is irreversibly indicated. In order to allow substantially residue-free removal of the security label from the article after first-time adhesive bonding, the security label is strippable. For this purpose it has an extensibility of at least 50%, preferably of at least 100%, and more preferably of at least 500%. The extensibility can be ensured more particularly by giving the detection layer an extensible design. However, there may also be further layers, such as a backing layer, for example, which are of extensible design. Extensibility on the part of the security label also means, however, that not all of the layers of the security label must follow the extension; indeed, individual layers may even be destroyed in the course of extension. All that is important is that the security label per se has the extensibility and remains coherent on extension, since the substantially residue-free redetachment from the bond substrate is achieved by way of the extension of the security label. The concept of extensibility refers to the maximum extension achieved by a specimen under test. The extensibility refers, moreover, to those regions of the security label in which specifically no predetermined breakage point has been provided.

The predetermined breakage point can be provided, for example, in the form of prior mechanical stressing of the security label at this point or in a larger region of the security label, or alternatively can be formed by giving the security label itself, at the corresponding point or in a larger region, a correspondingly weaker configuration, on the basis of the layer structure or of the chemical composition of the layers, this region therefore specifically not having the high tensile strength of the kind known from the prior art. In this sense, for example, a tapered region of the security label of the invention can be imagined as a predetermined breakage point.

A particularly simple way of introducing a predetermined breakage point into the security label is for the label to have kiss-cutting and/or perforation. The kiss-cutting and/or perforation may be designed in a wide variety of ways. It may be provided locally, for example, or may extend over a relatively large region; there may be two or more kiss-cuts and/or perforations provided, and/or the design of the kiss-cuts and/or perforations may be varied.

In a particularly preferred configuration, the region in which the predetermined breakage point is cited is marked, in order to ensure, even at the point of applying the security label to the article to be labelled, that the predetermined breakage point is disposed as far as possible over the gap that comes about when the article is opened—hence, in the case of the door, over the door aperture. The predetermined breakage point is able to fulfil its function in the best possible way when it is disposed in this way, since it is this point of the security label that is the most heavily loaded when the article is opened for the first time.

It is further preferred if the security label is designed in such a way that it can be removed substantially without residue from the article by stretching, starting exclusively from the predetermined breakage point. A result of this is that the security label can be removed without residue from the article only after the article has been opened and hence after the predetermined breakage point has been broken. Consequently, external manipulation is made more difficult additionally, independently of the actual optical feature that indicates such manipulation.

In a preferred configuration, the predetermined breakage point is designed so that the security label can be separated into two parts with an extremely low additional force. The expression “additional force” characterizes the force which must be applied in addition to the force that is necessary in any case to open the article. On the other hand, this additional force is adjusted so that unintended tearing of the security label is prevented.

By way of the mechanical properties of the security labels of the invention it is possible, furthermore, to adjust as desired the moment at which the at least one optical feature is triggered and hence indicates the attempt at first-time opening. This moment is associated with a threshold extension of the label, and depends on the nature of the optical feature that is used.

Generally speaking it is possible to make a distinction between two limiting cases in the requirements in this respect. Security labels of the invention offer a proposed solution for both cases in two advantageous configurations.

On the one hand it may be sensible to make the force needed to attain the abovementioned threshold extension as low as possible. Inventive security labels of this first advantageous configuration have a Young's modulus of less than about 100 MPa, preferably less than about 50 MPa, more preferably less than about 20 MPa, and more particularly less than about 15 MPa. A very low Young's modulus has the advantage that a lower force is needed to attain the threshold extension necessary for the triggering of the optical feature. The security label therefore, advantageously, has a particularly sensitive response to attempts at manipulation. The Young's modulus indicates the mechanical resistance with which a material opposes an elastic deformation. It is defined as the ratio of the stress σ needed for the extension ε achieved, where ε is the ratio formed from the change in length ΔL and the length L₀. The definition of the Young's modulus is elucidated, for example, in the Taschenbuch der Physik [H. Stöcker (ed.), Taschenbuch der Physik, 2nd ed., 1994, Verlag Harri Deutsch, Frankfurt]. Since the mechanical behaviour of the security labels is of central importance to the inventive function, FIG. 1 shows the typical course of a tension/extension curve of a kind which is qualitatively advantageous for security labels of the invention. Of particular significance therein are regimes I and II, Regime I defines the force needed to extend the security label in a marked way, while regime II describes the extent to which and the force with which the security label can be extended before it tears. The course of the plot in regime III is governed by the tensile strength of the security label.

On the other hand, it may be desired to set at a high level the force needed to attain the threshold extension referred to earlier on above. In this second advantageous configuration, the security label has a very high Young's modulus. The latter ought to be greater than about 300 MPa, preferably greater than about 400 MPa, more preferably greater than about 500 MPa. In one such configuration of the invention, the security label offers a high level of resistance to unintended or independent opening of the closure and/or triggering of the optical feature, which may occur, for example, by twisting of flaps or by vibrations during transit. This configuration therefore poses a solution for a security label from which a high level of robustness is expected.

Although security labels of the invention can be detached in the angular range between 180° and 90°, in a preferred configuration the residue-free removal from the article by stretching at an angle between 0° and 90° is possible, as is also illustrated in FIG. 2. The prior-art adhesive articles detached by stripping do not generally allow such a large angle for residue-free detachment, and, consequently, the handling of the security label on detachment is made unnecessarily more difficult (EP 0 563 272 B1).

Furthermore, in a preferred configuration, the security label has a resilience of at least 30%, preferably of at least 50%. As high a resilience as possible makes it easier to detach the security label without residue even in the case of high bond strengths. The resilience describes the capacity for immediate resiling (in percent) after a longitudinal extension by 50% of the initial length, and subsequent removal of the load. The resilience is a function of the resiled fraction over the total extended fraction. This extended fraction corresponds to the length of the extended sample minus the original lengths The resiled fraction corresponds to the length in the extended state minus the length after resiling. One method of determining the resilience is described in U.S. Pat. No. 4,024,312, for example.

Security labels of the invention comprise at least one layer of an adhesive. With great preference this adhesive layer is pressure-sensitively adhesive. Optionally, however, with great advantage, a preferably non-adhesive backing material is employed as a further layer. Self-adhesive labels of the invention further comprise at least one layer which contains at least one optical feature which alters its appearance under stretching—the detection layer. The adhesive layer may also be blind on one side with a release-action backing material (liner), from which the security label is detached before being bonded to the desired substrate. On the second side, the adhesive layer carries at least one non-adhesive layer. This non-adhesive layer may on the one hand be an abovementioned backing layer or else on the other hand may be the at least one detection layer which has the optical feature that alters its appearance under stretching.

The adhesive layer is composed advantageously of a pressure-sensitive adhesive formulation. Pressure-sensitive adhesives (PSAs) which can be employed include, in particular, all linear, star-shaped, branched, grafted or otherwise configured polymers, preferably homopolymers, random copolymers or block copolymers, which have a molar mass of at least 100 000 g/mol, preferably of at least 250 000 g/mol, very preferably of at least 500 000 g/mol. Preference is also given to at least a softening temperature of below 0° C., preferably of below −30° C. The molar mass in this context is the weight average of the molar mass distribution, as can be obtained, for example, via gel permeation chromatography analyses. Softening temperature in this context means the quasi-static glass transition temperature for amorphous systems, and the melting temperature for semi-crystalline systems, as can be determined, for example, by dynamic differential calorimetry measurements. Where numerical values are reported for softening temperatures, they refer to the middle-point temperature of the glass stage in the case of amorphous systems, and, in the case of semi-crystalline systems, to the temperature at maximum exotherm during the phase transition.

PSAs which can be used include all of the PSAs known to the skilled person, more particularly acrylate-based, natural rubber-based, synthetic rubber-based or ethylene-vinyl acetate-based systems. Combinations of these systems as well can be used in accordance with the invention.

Examples that may be mentioned, without wishing to undertake any restriction, as types which are advantageous in the sense of this invention include random copolymers starting from unfunctionalized α,β-unsaturated esters, and random copolymers starting from unfunctionalized alkyl vinyl ethers. Preference is given to using α,β-unsaturated alkyl esters of the general structure

a. CH₂═CH(R¹)(COOR²) (I)

where R¹ represents H or CH₃ and R² represents H or linear, branched or cyclic, saturated or unsaturated alkyl radicals having 1 to 30, more particularly having 4 to 18, carbon atoms.

Monomers used very preferably in the sense of the general structure (I) comprise acrylic and methacrylic esters with alkyl groups consisting of 4 to 18 C atoms. Specific examples of such compounds, without wishing to impose any restriction as a result of this enumeration, are n-butyl acrylate, n-pentyl acrylate, n-hexyl acrylate, n-heptyl acrylate, n-octyl acrylate, n-nonyl acrylate, lauryl acrylate, stearyl acrylate, stearyl methacrylate, their branched isomers, such as 2-ethylhexyl acrylate and isooctyl acrylate, and also cyclic monomers such as cyclohexyl acrylate or norbornyl acrylate and isobornyl acrylate, for example.

Likewise possible for use as monomers are acrylic and methacrylic esters which include aromatic radicals, such as phenyl acrylate, benzyl acrylate, benzoin acrylate, phenyl methacrylate, benzyl methacrylate or benzoin methacrylate, for example.

In addition it is possible to use, optionally, vinyl monomers from the following groups: vinyl esters, vinyl ethers, vinyl halides, vinylidene halides, and vinyl compounds which contain aromatic rings or heterocycles in a position. For the vinyl monomers which can be used optionally, mention may be made, by way of example, of selected monomers usable in accordance with the invention: vinyl acetate, vinylformamide, vinylpyridine, ethyl vinyl ether, 2-ethylhexyl vinyl ether, butyl vinyl ether, vinyl chloride, vinylidene chloride, acrylonitrile, styrene and α-methylstyrene.

Further monomers useable in accordance with the invention are glycidyl methacrylate, glycidyl acrylate, allyl glycidyl ether, 2-hydroxyethyl methacrylate, 2-hydroxyethyl acrylate, 3-hydroxypropyl methacrylate, 3-hydroxypropyl acrylate, 4-hydroxybutyl methacrylate, 4-hydroxybutyl acrylate, acrylic acid, methacrylic acid, itaconic acid and its esters, crotonic acid and its esters, maleic acid and its esters, fumaric acid and its esters, maleic anhydride, methacrylamide, and also N-alkylated derivatives, acrylamide and also N-alkylated derivatives, N-methylolmethacrylamide, N-methylolacrylamide, vinyl alcohol, 2-hydroxyethyl vinyl ether, 3-hydroxypropyl vinyl ether and 4-hydroxybutyl vinyl ether.

In the case of rubber, including synthetic rubber, as starting material for the PSA, there are further possibilities for variation, whether from the group of the natural rubbers or synthetic rubbers or from any desired blend of natural rubbers and/or synthetic rubbers, it being possible to select the natural rubber or rubbers in principle from all available grades such as, for example, crepe, RSS, ADS, TSR or CV grades, depending on the required level of purity and viscosity, and the synthetic rubber or rubbers from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends of these.

Furthermore, in order to improve the processing properties, it is possible to add preferably thermoplastic elastomers to the rubbers, with a weight fraction of 10% to 50% by weight, based on the overall elastomer fraction. Representatives that may be mentioned at this point include in particular the especially compatible polystyrene-polyisoprene-polystyrene (SIS) and polystyrene-polybutadiene-polystyrene (SBS) types.

Likewise advantageously possible for use as base materials for adhesive layers are block copolymers. In these copolymers, individual polymer blocks are linked covalently to one another. The blockwise linkage may be in a linear form, or alternatively in a star-shaped or graft copolymer version. One example of a block copolymer which can be employed advantageously is a linear triblock copolymer whose two end blocks have a softening temperature of at least 40° C., preferably at least 70° C., and whose middle block has a softening temperature of not above 0° C., preferably not above −30° C. Higher block copolymers, such as tetrablock copolymers, can likewise be employed. It is important that there are at least two polymer blocks of the same or different kind present in the block copolymer that have a softening temperature in each case of at least 40° C., preferably at least 70° C., and that are separated from one another in the polymer chain by at least one polymer block having a softening temperature of not above 0° C., preferably not above −30° C. Examples of polymer blocks are polyethers such as polyethylene glycol, polypropylene glycol or polytetrahydrofuran, polydienes, such as polybutadiene or polyisoprene, hydrogenated polydienes, such as polyethylenebutylene or polyethylenepropylene, polyesters, such as polyethylene terephthalate, polybutanediol adipate or polyhexanediol adipate, polycarbonate, polycaprolactone, polymer blocks of vinylaromatic monomers, such as polystyrene or poly-α-methylstyrene, polyalkyl vinyl ethers, polyvinyl acetate, polymer blocks of α,β-unsaturated esters such as, more particularly, acrylates or methacrylates, for example. Corresponding softening temperatures are known to the skilled worker. Alternatively he or she will find them, for example, in the Polymer Handbook [J. Brandrup, E. H. Immergut, E. A. Grulke (eds.), Polymer Handbook, 4th Ed., 1999, Wiley, New York]. Polymer blocks may be constructed from copolymers.

Tackifying resins which can be used optionally are, without exception, all known tackifier resins described in the literature. Representatives that may be mentioned include the rosins, their disproportionated, hydrogenated, polymerized and esterified derivatives and salts, and the aliphatic and aromatic hydrocarbon resins, terpene resins and terpene-phenolic resins. Any desired combinations of these and further resins may be used in order to adjust the properties of the resultant adhesive in accordance with what is required.

As plasticizers which can likewise be employed optionally it is possible to use all plasticizing substances known from self-adhesive technology, These include, among others, the paraffinic and naphthenic oils, (functionalized) oligomers such as oligobutadienes and oligoisoprenes, liquid nitrile rubbers, liquid terpene resins, vegetable and animal fats and oils, phthalates and functionalized acrylates. PSAs of the kind indicated above may further comprise additional constituents such as rheological additives, catalysts, initiators, stabilizers, compatibilizers, coupling reagents, crosslinkers, antioxidants, further ageing inhibitors, light stabilizers, flame retardants, pigments, dyes, fillers and/or expandants and also, optionally, solvents.

As materials from which the at least one optionally employable backing layer is constructed it is possible to use two classes: extensible layers (extensibility of at least 50%, preferably at least 100%, more preferably greater than 500%) and non-extensible layers. Non-extensible layers or films can be employed for the purposes of this invention more particularly when for the reason, for example, of the brittleness of the backing materials or of controlled damage to the backing they feature a low tensile strength, so that tearing occurs when the security label is stretched during detachment. In this case, the extensibility of the security label is characterized substantially by the extensibility of the adhesive layer.

The backing film is produced using film-forming or extrudable polymers. One preferred embodiment uses polyolefins. Preferred polyolefins are prepared from ethylene, propylene, butylene and/or hexylene, in which case it is possible to polymerize the pure monomers in each case, or else mixtures of the stated monomers are copolymerized. Through the polymerization process and through the selection of the monomers it is possible to control the physical and mechanical properties of the polymer film, such as the softening temperature and/or tensile strength, for example.

A further preferred embodiment of this invention uses polyvinyl acetates. As well as vinyl acetate, polyvinyl acetates may also include vinyl alcohol as a comonomer, in which case the free alcohol fraction can be varied within wide limits. One further preferred embodiment of this invention uses polyester as backing film. One particularly preferred embodiment of this invention uses polyesters based on polyethylene terephthalate (PET). A further preferred embodiment of this invention uses polyvinyl chlorides (PVC) as backing film. To increase the temperature stability, the polymer constituents present in these films may be prepared using stiffening comonomers. Furthermore, the films may be radiation-crosslinked in the course of the inventive operation, in order to produce the same improvement in properties. Where PVC is employed as a base material for the film, it may optionally include plastifying components (plasticizers). A further preferred embodiment of this invention uses polyamides to produce films. The polyamides may consist of one dicarboxylic acid and one diamine or of two or more dicarboxylic acids and diamines. Besides dicarboxylic acids and diamines it is also possible to employ amines and carboxylic acids of higher functionality, both as they are and in combination with the abovementioned dicarboxylic acids and diamines. The film is stiffened using preferably cyclic, aromatic or heteroaromatic starting monomers. One further preferred embodiment of this invention uses polymethacrylates to produce films. Here the glass transition temperature of the film can be controlled through the choice of monomers (methacrylates and in some cases acrylates as well). Furthermore, the polymethacrylates may also include additives, in order, for example, to increase the flexibility of the film or to raise or lower the glass transition temperature or to minimize the formation of crystalline segments. A further preferred embodiment of this invention uses polycarbonates to produce films. Furthermore, in a further embodiment of this invention, polymers and copolymers based on vinylaromatics and vinylheteroaromatics may be used to produce the backing film.

Particularly appropriate as starting materials for extensible backing layers are polyolefins. Here as well, preferred polyolefins are prepared from ethylene, propylene, butylene and/or hexylene, it being possible in each case to polymerize the pure monomers, or else mixtures of the stated monomers are copolymerized. Through the polymerization process and through the selection of the monomers it is possible to control the physical and mechanical properties of the polymer film, such as the softening temperature and/or extensibility, for example. Furthermore, polyurethanes can be used with advantage as starting materials for extensible backing layers. Polyurethanes are chemically and/or physically crosslinked polycondensates constructed typically from polyols and isocyanates. Depending on the nature of the individual components and the proportions in which they are used, extensible materials are obtainable which can be employed advantageously in the context of this invention. Raw materials which are available to the formulator for this purpose are specified in EP 894 841 B1 and EP 1 308 492 B1, for example. The skilled worker is aware of further raw materials from which backing layers of the invention can be constructed. It is advantageous, furthermore, to use rubber-based materials in backing layers, in order to realise extensibility. As rubber or synthetic rubber, or blends produced therefrom, as starting material for extensible backing layers, the natural rubber may be selected in principle from all available grades such as, for example, crepe, RSS, ADS, TSR or CV grades, depending on the required level of purity and viscosity, and the synthetic rubber or rubbers can be selected from the group of the randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends of these.

Usable with particular advantage as materials for extensible backing layers are block copolymers. In these copolymers, individual copolymer blocks are linked covalently to one another. The blockwise linking can be in a linear form, or alternatively in a star-shaped or graft copolymer variant. One example of a block copolymer which can be used with advantage is a linear triblock copolymer whose two end blocks have a softening temperature of at least 40° C., preferably at least 70° C., and whose middle block has a softening temperature of not above 0° C., preferably not above −30° C. Higher block copolymers, such as tetrablock copolymers, can likewise be employed. It is important that there are at least two polymer blocks of the same or different kind present in the block copolymer that have a softening temperature in each case of at least 40° C., preferably at least 70° C., and that are separated from one another in the polymer chain by at least one polymer block having a softening temperature of not above 0° C., preferably not above −30° C. Examples of polymer blocks are polyethers such as polyethylene glycol, polypropylene glycol or polytetrahydrofuran, polydienes, such as polybutadiene or polyisoprene, hydrogenated polydienes, such as polyethylenebutylene or polyethylenepropylene, polyesters, such as polyethylene terephthalate, polybutanediol adipate or polyhexanediol adipate, polycarbonate, polycaprolactone, polymer blocks of vinylaromatic monomers, such as polystyrene or poly-α-methylstyrene, polyalkyl vinyl ethers, polyvinyl acetate, polymer blocks of α,β-unsaturated esters such as, more particularly, acrylates or methacrylates, for example. Corresponding softening temperatures are known to the skilled worker. Alternatively he or she will find them, for example, in the Polymer Handbook [J. Brandrup, E. H. Immergut, E. A. Grulke (eds.), Polymer Handbook, 4th Ed., 1999, Wiley, New York]. Polymer blocks may be constructed from copolymers.

To produce a backing material it may be appropriate here as well to add additives and other components which improve the film-forming properties, reduce the tendency to form crystalline segments and/or, in a targeted way, improve or else, where appropriate, impair the mechanical properties.

Backing materials can be pretreated in accordance with the prior art—that is, they can have been subjected, for example, to a chemical and/or physical pretreatment. Corona pretreatment or plasma pretreatment, for example, is conceivable here.

The detection layer which has the optical feature that alters its appearance under stretching is of non-adhesive configuration if it represents the uppermost layer in the label assembly. It may be realised as a print, including a multiple print, in which case individual print elements may be of full-area configuration while others are of partial configuration, or else it may be realised as a stamping film, such as a hot-stamping film, for example. Optical features which alter their appearance under stretching may also be introduced in different layers into the security label of the invention. It is also possible for an optical feature to be composed of individual features that are situated in different layers.

Optionally it is possible for further layers to be employed, which can be selected so as to introduce additional functions into the security label, but which essentially do not lead to any change in the tension/extension behaviour of the label. Examples of such layers which can optionally be used may be primer layers, release layers or barrier layers. Primer layers and release layers particularly can be employed in full-area or partial format.

In those label constructions which do not contain an additional backing layer, the adhesive layer is selected so that it leads to the mechanical properties according to the invention in the overall assembly. The thickness of the adhesive layer in this case is typically between 15 μm and 1000 μm, preferably between 50 μm and 500 μm. In those label constructions which do include an additional backing layer, the thickness of the adhesive layer is between 5 μm and 1000 μm, preferably between 15 μm and 500 μm. In that case the backing layer typically has a thickness of 5 μm to 1000 μm.

To produce a liner which can be used in accordance with the invention it is possible, where the liner is a film-based liner, to make use in principle of all film-forming and extrudable polymers. The release film (liner) is composed of a backing film furnished on one or both sides with a release varnish, preferably a silicone-based varnish. In the case of liners furnished on both sides with release varnish, the release varnishes are preferably graded, i.e. the release values differ on the top and bottom sides. One preferred embodiment of this invention uses polyolefins as backing material for the release film. Preferred polyolefins are prepared from ethylene, propylene, butylene and/or hexylene, in which case the pure monomers can be polymerized, or else mixtures of the stated monomers are copolymerized. Polyester-based film liners can likewise be employed with advantage.

In addition, various papers, either alone or, optionally, in combination with a stabilizing extrusion coating, are suitable as backing materials for release materials. All of the stated release carriers acquire their anti-adhesive properties by virtue of one or more coating operations, with a silicone-based release, for example. This application may take place on one or both sides.

Where the adhesive layer is required to meet the mechanical requirements which are imposed on the security label in the sense of this invention, then it is preferred to employ rubber-based systems or block copolymer-based systems.

The overall thickness of the security labels without liners ought to be between 25 μm and 1500 μm, preferably between 35 μm and 500 μm. Where a backing layer is used, then it is advantageous for the thickness of the adhesive layer and the thickness of the backing layer to be of a similar order of magnitude (variant A: layer thickness ratio of adhesive layer to backing layer of about 25:75 to about 75:25). It is likewise advantageous if the thickness of the adhesive layer is substantially higher than that of the backing layer (variant B: about 85:15 to about 95:5). It is in accordance with the invention, moreover, if the thickness of the adhesive layer is substantially lower than the thickness of the backing layer (variant C: about 10:90 to about 25:75). All other layer-thickness ratios are of course likewise in accordance with the invention. In variant A the adhesive layer and backing layer are preferably selected so that they both correspond essentially per se to the mechanical property criteria of the invention. In variant B, it is the adhesive layer in particular that contributes to the mechanical label properties. The backing layer need not per se meet the criteria of the invention. It is possible to conceive, for example, of the backing layer not having the extensibility of the adhesive layer, and of then tearing on extension as a result of a sufficiently low tensile strength. In variant C, the mechanical properties of the backing layer make the primary contribution to the mechanical properties of the label. In this case the adhesive layer need not have any particularly high extensibility or tear strength.

In order to permit as wide as possible a range of use of the security label, including more particularly its use within the field of catering logistics, it can in one very advantageous embodiment be of a construction such that it can be used even at extreme temperatures. More particularly the security label can be used even at temperatures down to about −50° C., preferably down to about −30° C., thus retaining the properties essential to the invention. An upper temperature limit for security labels of this kind is defined in general by the cohesion of the adhesive layer and/or of any backing layers. Furthermore, the security label is preferably of a construction such that it can be used even at temperatures of up to about 100° C., preferably up to about 60° C.

The optical feature of the detection layer serves as an irreversible indication of detachment of the security label from the article, even partial detachment. This is realised by the detachment of the security label being accompanied by a change in the appearance, the appearance after first-time adhesive bonding hence differing in comparison to the appearance after the detachment with stretching. An alteration of this kind in the appearance may take the form, for example, of the appearance initially being glossy, and turning into a matt appearance in the course of detachment. Such a transformation may take place, for example, as a result of stretching with only partial resiling. One alternative is for the optical feature to be designed in such a way that, following a detachment with stretching, a different-coloured appearance is visible. This can be brought about, for example, by different regions of the security label initially having different colours, which then mix with one another on stretching.

The optical feature may further take the form of a hologram, more particularly an embossed hologram. After stretching, as a result of the expansion of the hologram area, the contrast and/or the brightness of the hologram becomes lower than in the case of first-time bonding. In this case as well, consequently, detachment with stretching is recognizable without auxiliary means.

A further possibility is for the optical feature to take the form of a graphical pattern. After stretching, the graphical pattern is recognizably different and therefore serves as an indicator of first-time opening. For this purpose the graphical pattern may, for example, have lines which, after stretching, exhibit a different course and/or a different orientation.

In accordance with the invention it is also possible, advantageously in accordance with the invention, for combinations of two or more optical features to be used which recognizably alter on extension and which are no longer present in the original appearance following detachment of the security label.

Moreover, the security label may also be designed so that it has a storage layer into which information can be introduced. The storage layer may be an additional layer. Alternatively, for example, the storage layer may be formed by a further layer, such as a backing layer, of the security label. The information can be introduced, for example, by printing of the storage layer, embossing, writing by means of a laser, or the like.

The security label of the invention is especially suitable for sealing doors, such as trap doors, sliding doors, leaf doors, windows, containers with lids or the like. In particular it is configured in such a way that it can be used for sealing means of transport of all kinds, and therefore also withstands the corresponding weathering effects that occur in this field of use, and also allows the opening of an outwardly sealed door from the inside.

### BRIEF DESCRIPTION OF THE DRAWINGS

Further details, features, objectives and advantages of the present invention will be elucidated in more detail below with reference to a drawing of preferred exemplary embodiments. In the drawing:

FIG. 1 shows the typical course of the tension/extension curve of a security label,

FIG. 2 shows, in a diagrammatic representation, the angle of detachment of a security label,

FIG. 3 shows, in diagrammatic representation, a side view of the security label of the invention on a door before first-time opening,

FIG. 4 shows the security label from FIG. 3 on first-time opening of the door,

FIG. 5 shows the security label of FIG. 3 after first-time opening of the door,

FIG. 6 shows the security label of FIG. 4 during the stripping process, and

FIG. 7 shows various alternative configurations of kiss-cuts on a security label.

### DETAILED DESCRIPTION OF THE PRESENTLY PREFERRED EMBODIMENTS

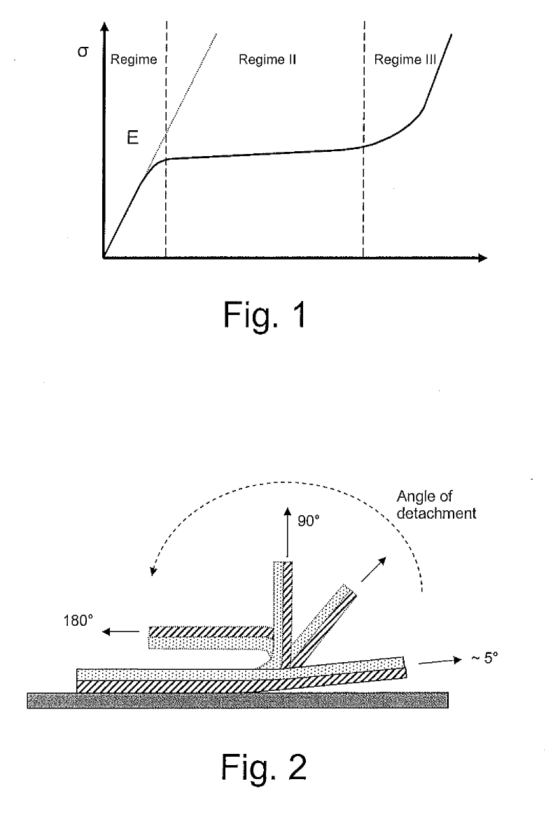

FIG. 1 shows a typical course of a tension/extension curve of a security label 1 of the invention. In the region of regime I, the tensile force increases approximately linearly as the extension grows; in other words, with growing force, the security label 1 is extended continuously. In the region of regime II, the tensile force required for further extension of the security label 1 is virtually constant. This region is particularly important for the maximum extensibility of the security label 1. Then, in the region of regime III, a growing tensile force is again necessary for further extension of the security label 1.

FIG. 2 shows, in a diagrammatic representation, for better understanding the detachment angle, in other words the angle at which an inventive security label 1 is removable residuelessly from the bond substrate 2 (an arbitrary article). In order to make the handling of the security label 1 as easy as possible, the detachment angle ought to be as large as possible. There are limits on this, however, as a result of the fact that stretching of the security label 1 must be possible without it tearing. In the case of too large a detachment angle, however, the accompanying crease in the security label 1, in conjunction with the bond strength on the article 2, can mean an excessive load at the crease and hence a tear occurring. The residueless removal from the article 2 by stretching of the security label 1 is possible in a preferred embodiment, as shown, at an angle between 0° and 90°. The prior-art adhesive tapes do not generally allow such a large angle for residueless detachment, but instead typically only allow an angle of between 0° and up to 45°, as a result of which the handling of the security label on detachment is made unnecessarily more difficult.

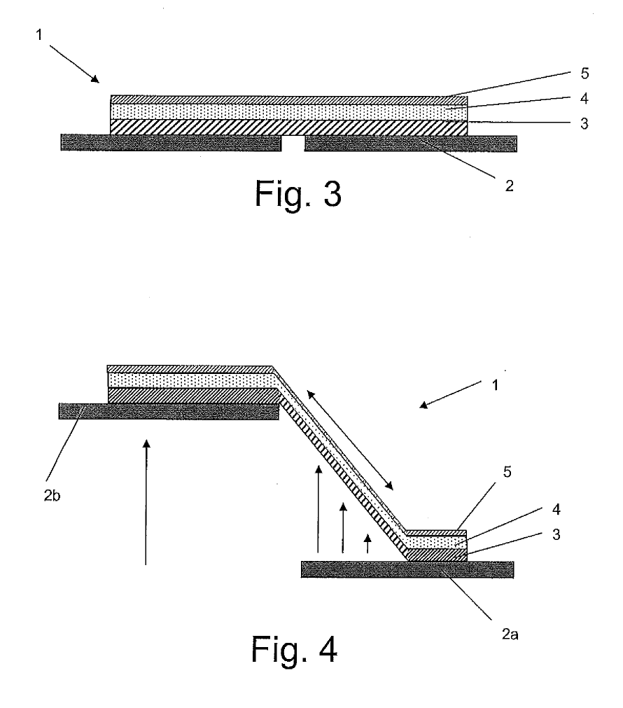

FIG. 3 shows, in a diagrammatic representation, a side view of a security label 1 of the invention adhered to a door 2. In this case the security label 1 serves as a detector of first-time opening: that is, it shows whether the door 2, which in this case consists of two leaves 2a and 2b displaceable against one another, has been opened or not after sealing with the security label 1.

The security label 1 first has an adhesive layer 3 with which it is applied to the door leaves 2a, 2b. The adhesive layer 3 is disposed on a backing 4 which in this case serves as a structure-forming layer of the security label 1 and substantially determines the physical properties of the security label 1. Disposed next on the backing 4 is a detection layer 5, which in any case has an optical feature that irreversibly indicates an attempt at detachment of the security label from the door 2. Where appropriate, there may also be a protective layer provided on the detection layer, or there may be further functional layers provided. Also, provision may have been made for two or more functions to be provided by only one layer; the number of layers needed, therefore, is variable. Concerning the configurational possibilities of the layer construction and the composition thereof, reference is made to the general description.

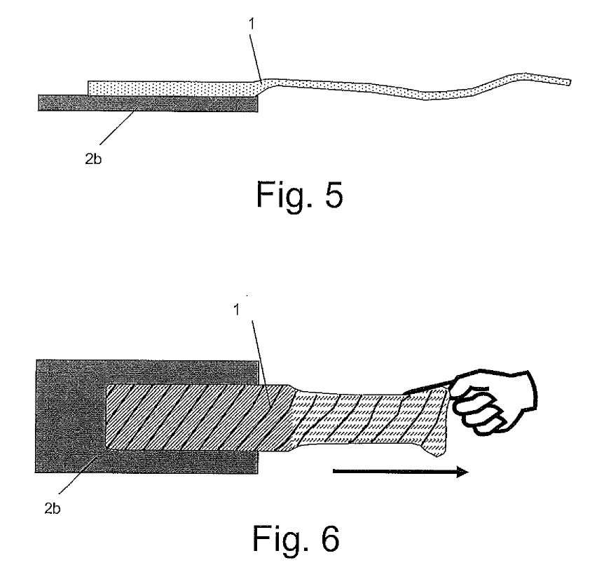

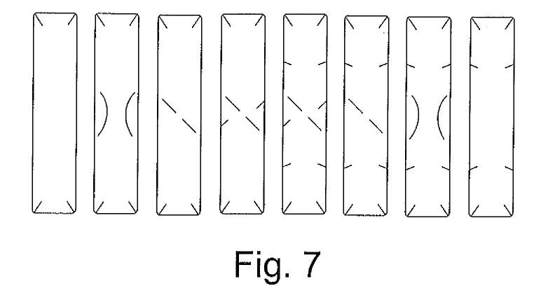

When the article 2 is then opened for the first time, as illustrated in FIG. 4—in this case, therefore, a displacement of the two door leaves 2a, 2b relative to one another—the security label 1 is stretched during the opening process. In this case, the security label 1 begins to part, with stretching, at least from one of the two door leaves 2a, 2b—in this case in fact, owing to the direction of movement, only from the door leaf 2a. When the door 2 has been opened far enough, the security label 1 is removed without residue from the door leaf 2a, but continues to adhere to the other door leaf 2b (FIG. 5). The portion of the security label 1 that has detached from the door leaf 2a can then be used as a grip tab for further removal of the security label 1 from the door leaf 2b. Removal from the door leaf 2b then takes place, likewise with stretching of the security label 1, by pulling it at a suitable stripping angle (FIG. 6).

From the depiction of the security label in FIG. 6 in particular, moreover, it is possible to see the irreversible change in the appearance of the security label 1 before and after stretching. Before stretching (left-hand half of the security label 1), the security label 1 has straight, continuous lines. One group of lines is of thicker design, the second group of lines thinner. Furthermore, the lines of the two groups run at a distinctly recognizable angle relative to one another. After stretching (right-hand half of the security label 1), the thicker lines are still recognizable as continuous lines, but their course is no longer linear. The thinner lines, in contrast, have interruptions, and thus are no longer continuous. Moreover, there are now regions in which both groups of lines run substantially parallel to one another, having therefore changed their disposition in this respect. Further, it is apparent from a comparison of the regions of the security label 1 before and after stretching that the coloured appearance is changed. As a result of the stretching, there is a change in the colour distribution in the security label 1. In the present case, the security label 1 becomes partially transparent as a result of stretching.

FIG. 7 then shows different modes and dispositions of kiss-cuts on a security label 1. Initially, for all of the security labels 1, there are kiss-cuts at the outer edge, which are intended to make it more difficult to attempt without authorization to detach the labels from the article 2. The intention is that the security label 1 should be removable from the article 2, preferably, only by opening of the article 2.

Moreover, there are different modes and forms of kiss-cuts provided in the middle region of the security labels 1. These kiss-cuts are one of the above-described possibilities of forming a predetermined breakage point. In this case the kiss-cuts extend over a relatively large region, so that, when being adhered to the article 2, it is not necessary to align the security label 1 with one hundred percent accuracy, thereby making handling as easy as possible.

The following design example is intended to illustrate further the concept of the invention, though not to restrict it.

A siliconized liner was coated with 12 μm of a styrene block copolymer-based PSA that contained 30% of a polyterpene resin. An extensible backing film, which was likewise styrene block copolymer-based and had been made non-tacky, was laminated onto the open side. The layer thickness of the backing film was 75 μm. The bale material was first printed white over its full area and then printed blue over its full area, on a printing machine. Finally, oblique black lines were applied by printing. The material was slit to labels of format 22 mm×99 mm and stripped from the matrix. Specimens of these labels were detached from the liner and investigated in tension/extension tests. A Young's modulus of approximately 16 MPa, a resilience of 60%, and an extensibility (maximum extension) of 700% were found. Further specimens of this type of label were detached from the liner and bonded to multi-trip freight containers made of polypropylene. The freight containers had two closure flaps on their top face. Bonding was carried out in such a way that the security label was bonded with one half on the first opening flap and with the second half on the second opening flap. In this way the container was sealed. When an attempt at opening was made, the security label was irreversibly deformed. Moreover, the optical feature changed its appearance, to the effect that the lines which ran straight before stripping no longer ran straight after stripping, and in fact were in some cases interrupted. In addition, the white underneath layer showed through the blue layer after stripping. In other words, the attempt at first-time opening was indicated in a clearly recognizable way. In order to open the container completely, the security label was detached by stripping. There were no residues recognizably visible to the eye on the container surface following detachment.

1. Security label for use as a detector of first-time opening of an article, having an adhesive layer for application to the article, and a detection layer,
the detection layer having an optical feature which irreversibly indicates an attempt at detachment from the article,
the security label having an extensibility of at least 50% and being removable substantially without residue from the article by stretching, wherein
the security label has a predetermined breakage point at which the security label can be divided into two parts on first-time opening.

2. Security label according to claim 1, wherein the predetermined breakage point is formed by kiss-cutting and/or perforation.

3. Security label according to claim 1, wherein the security label is removable substantially without residue from the article by stretching, starting from the predetermined breakage point, exclusively after the breakage of the predetermined breakage point.

4. Security label for use as a detector of first-time opening of an article, having an adhesive layer for application to the article, and a detection layer,
the detection layer having an optical feature which irreversibly indicates an attempt at detachment from the article,
the security label having an extensibility of at least 50% and being removable substantially without residue from the article by stretching,
wherein the security label, by virtue of the opening of the article, is stretchable and is detachable substantially without residue from the article at least one one side.

5. Security label according to claim 1 wherein the security label is removable substantially without residue from the article by stretching at an angle between 0° and 90°.

6. Security label according to claim 1, wherein the security label has an extensibility of at least 100%, preferably of at least 500%.

7. Security label according to any one of the preceding claims, wherein the security label has a resilience of at least 30%, preferably of at least 50%.

8. Security label according to claim 1, wherein the security label has a Young's modulus of less than about 100 MPa, preferably less than about 50 MPa, more preferably less than about 20 MPa, more particularly less than about 15 MPa.

9. Security label according to claim 1, wherein the security label has a Young's modulus of greater than about 300 MPa, preferably greater than about 400 MPa, more preferably greater than about 500 MPa.

10. Security label according to claim 1, wherein the security label can be used at temperatures down to about −50° C., preferably down to about −30° C.

11. Security label according to claim 1, wherein the security label can be used at temperatures up to about 100° C., preferably up to about 60° C.

12. Security label according to claim 1, wherein the optical feature is designed such that the appearance after first-time adhesive bonding is glossy and the appearance after stretching is matt.

13. Security label according to claim 1, wherein the optical feature is designed such that a different-coloured appearance is visible after stretching.

14. Security label according to claim 1, wherein the optical feature is designed as a hologram, more particularly as an embossed hologram, and in that the contrast and/or brightness after stretching is lower than at first-time adhesive bonding.

15. Security label according to claim 1, wherein the optical feature is designed as a graphic pattern, more particularly with lines, and in that the graphic pattern after stretching is recognizably different: more particularly, the lines have a different course and/or a different orientation.

16. Security label according to claim 1, wherein the security label has a storage layer into which information can be introduced by means, more particularly, of printing, embossing or writing.

17. Security label according to any claim 1, wherein the detection layer is extensible.

18. Security label according to claim 1, wherein in addition to the detection layer there is a backing layer which, preferably, is extensible.

19. Security label according to claim 1, wherein the adhesive layer is designed as a pressure-sensitive adhesive layer.

20. A method of using a security label according to claim 1, wherein the security label is applied to one of sealing doors, windows and containers with lids.

21. A method of detaching a security label without residue from an article secured with a security label,
designing the security label in accordance with claim 1, and upon opening the article, the security label is divided into two parts, and
each individual part is detached substantially without residue by stretching, preferably starting from the predetermined breakage point.

22. A method of detaching a security label without residue from an article secured with a security label,
designing the security label in accordance with claim 1, and upon opening of the article, the security label is stretched and is detached substantially without residue from the article at least on one side.

23. The method according to claim 22, wherein the security label is detached substantially without residue from the article by stretching on the other side.
